(19) United States
(12) Patent Application Publication
(10) Pub. No.: US 2026/0290693 A1
(43) Pub. Date: Sep. 24, 2026

(54) MULTILAYER CERAMIC ELECTRONIC COMPONENT AND MANUFACTURING METHOD OF THE SAME

(71) Applicant: TAIYO YUDEN CO., LTD., Tokyo (JP)

(72) Inventors: Chizuru TOMIKAWA, Tokyo (JP); Tomoaki NAKAMURA, Tokyo (JP); Kenichi HIRAOKA, Tokyo (JP); Junichi SHINOZAKI, Tokyo (JP)

(73) Assignee: TAIYO YUDEN CO., LTD., Tokyo (JP)

(21) Appl. No.: 19/649,289

(22) Filed: Apr. 16, 2026

Related U.S. Application Data
(63) Continuation of application No. PCT/JP2024/039789, filed on Nov. 8, 2024.

(30) Foreign Application Priority Data
Nov. 8, 2023 (JP) 2023-191067
Nov. 8, 2023 (JP) 2023-191068

(51) Int. Cl. H01G 4/12; H01G 4/008; H01G 4/30

(52) U.S. Cl. CPC H01G 4/1227; H01G 4/008; H01G 4/30

(57) ABSTRACT

A multilayer ceramic electronic component includes an element body in which internal electrodes and dielectric layers mainly composed of ceramic are alternately laminated in a first direction, the element body having end surfaces facing each other in a second direction, the internal electrodes being alternately drawn to the end surfaces; and external electrodes respectively in contact with the internal electrodes, wherein when one of the dielectric layers in a capacitance section, which is a central portion in the second direction and has the internal electrodes overlapping each other, is divided at equal intervals in the first direction into three regions having a pair of first regions and a second region between the pair of first regions, a first molar ratio of phosphorus to a main component metal element of ceramic in the pair of first region is greater than a second molar ratio in the second region.

### CROSS-REFERENCE TO RELATED APPLICATION

This application is a continuation application of PCT/JP2024/039789 filed on Nov. 8, 2024, which claims priorities of Japanese Patent Applications No. 2023-191067 filed on Nov. 8, 2023 and No. 2023-191068 filed on Nov. 8, 2023, the entire contents of each are incorporated herein by reference.

### FIELD

A certain aspect of the present disclosure relates to a multilayer ceramic electronic component and a manufacturing method of the same.

### BACKGROUND

In a multilayer ceramic electronic component such as a multilayer ceramic capacitor in which internal electrodes and dielectric layers are laminated, it is known that the grain size of ceramic grains in a first region of the dielectric layers on the internal electrode side is smaller than the grain size of ceramic grains in a second region of the dielectric layers in the center portion (Refer to, for example, Japanese Examined Patent Publication No. 2014-35384.). In a similar multilayer ceramic electronic component, it is known to add phosphorus to the inner electrodes on the main surface side (Refer to, for example, Japanese Examined Patent Publication No. 2022-84400.).

### SUMMARY

According to a first aspect of the present disclosure, there is provided a multilayer ceramic electronic component including: an element body in which internal electrodes and dielectric layers mainly composed of ceramic are alternately laminated in a first direction, the element body having a pair of end surfaces facing each other in a second direction, the internal electrodes being alternately drawn to the pair of end surfaces; and a pair of external electrodes respectively in contact with the internal electrodes drawn to the pair of end surfaces, wherein when one of the dielectric layers in a capacitance section, which is a central portion of the element body in the second direction as viewed in the first direction and has the internal electrodes overlapping each other, is virtually divided at equal intervals in the first direction into three regions having a pair of first regions and a second region sandwiched between the pair of first regions, a first molar ratio of phosphorus to a main component metal element of ceramic in the pair of first region is greater than a second molar ratio of phosphorus to the main component metal element in the second region.

According to a second aspect of the present disclosure, there is provided a multilayer ceramic electronic component including: an element body in which internal electrodes and dielectric layers mainly composed of ceramic are alternately laminated in a first direction, the element body having a pair of end surfaces facing each other in a second direction, the internal electrodes being alternately drawn to the pair of end surfaces; and a pair of external electrodes respectively in contact with the internal electrodes drawn to the pair of end surfaces, wherein a first molar ratio of phosphorus to a main component metal element of ceramic in a capacitance section in which the internal electrodes overlap each other is greater than a second molar ratio of phosphorus to the main component metal element in an end margin region in which some of the internal electrodes are not provided, the capacitance section is a central portion of the element body in the second direction as viewed in the first direction, and the end margin region is an end portion of the element body in the second direction as viewed in the first direction.

According to a third aspect of the present disclosure, there is provided a manufacturing method of a multilayer ceramic electronic component, including: preparing an element body in which green sheets containing ceramic particles and metal patterns containing phosphorus are alternately laminated in a first direction; firing the element body to form internal electrodes alternately drawn to a pair of end surfaces of the element body facing each other in a second direction from the metal patterns and to form dielectric layers from the green sheets; and forming a pair of external electrodes in contact with the internal electrodes drawn to the pair of end surfaces, wherein, after firing the element body, when one of the dielectric layers in a capacitance section, which is a central portion of the element body in the second direction as viewed in the first direction and has the internal electrodes overlapping each other, is virtually divided at equal intervals in the first direction into three regions having a pair of first regions and a second region sandwiched between the pair of first regions, a first molar ratio of phosphorus to a main component metal element of ceramic in the pair of first region is greater than a second molar ratio of phosphorus to the main component metal element in the second region.

According to a fourth aspect of the present disclosure, there is provided a manufacturing method of a multilayer ceramic electronic component, including: preparing an element body in which lamination sheets are laminated in a first direction, the lamination sheets having metal patterns and dielectric patterns containing ceramic particles formed on green sheets containing the ceramic particles, the dielectric patterns being formed between the metal patterns; firing the element body to form internal electrodes alternately drawn to a pair of end surfaces of the element body facing each other in a second direction from the metal patterns and to form dielectric layers from the green sheets and the dielectric patterns; and forming a pair of external electrodes in contact with the internal electrodes drawn to the pair of end surfaces, wherein a first molar ratio of phosphorus to a main component metal element of the ceramic particles in the green sheets sandwiched between the metal patterns in the first direction is greater than a second molar ratio of phosphorus to the main component metal element in the dielectric patterns.

According to a fifth aspect of the present disclosure, there is provided a manufacturing method of a multilayer ceramic electronic component, including: preparing an element body in which lamination sheets are laminated in a first direction, the lamination sheets having metal patterns containing phosphorus and dielectric patterns containing ceramic particles formed on green sheets containing the ceramic particles, the dielectric patterns being formed between the metal patterns; firing the element body to form internal electrodes alternately drawn to a pair of end surfaces of the element body facing each other in a second direction from the metal patterns and to form dielectric layers from the green sheets and the dielectric patterns; and forming a pair of external electrodes in contact with the internal electrodes drawn to the pair of end surfaces, wherein a first molar ratio of phosphorus to a main component metal element of ceramic in a capacitance section in which the internal electrodes overlap each other is greater than a second molar ratio of phosphorus to the main component metal element in an end margin region in which some of the internal electrodes are not provided, the capacitance section is a central portion of the element body in the second direction as viewed in the first direction, and the end margin region is an end portion of the element body in the second direction as viewed in the first direction.

### BRIEF DESCRIPTION OF THE DRAWINGS

FIG. 1 is a partial cross-sectional perspective view of a multilayer ceramic capacitor according to an embodiment.

FIG. 2 is a cross-sectional view taken along the line A-A of FIG. 1.

FIG. 3 is a cross-sectional view taken along the line B-B of FIG. 1.

FIG. 4 is a cross-sectional view taken along the line C-C of FIG. 1.

FIG. 5 is an enlarged schematic diagram of a dielectric layer of a multilayer ceramic capacitor according to the first embodiment.

FIG. 6 is a flowchart illustrating an example of a manufacturing method of a multilayer ceramic capacitor according to the first embodiment.

FIG. 7A is a plan view illustrating an example of a lamination sheet in a manufacturing method of a multilayer ceramic capacitor according to the first embodiment.

FIG. 7B is a cross-sectional view taken along the line A-A of FIG. 7A.

FIG. 8 is a cross-sectional view illustrating an example of a laminated sheets body in a manufacturing method of a multilayer ceramic capacitor according to the first embodiment.

FIG. 9 is a schematic diagram illustrating a characteristic of a molar ratio of phosphorus with respect to position Z in a dielectric layer in a capacitance section.

FIG. 10 is a schematic diagram illustrating an average of a molar ratio of phosphorus in each region in a dielectric.

FIGS. 11A and 11B are diagrams illustrating examples of methods for measuring a grain size.

FIG. 12 is an enlarged schematic view of a dielectric layer between internal electrodes in a capacitance section of a multilayer ceramic capacitor according to the second embodiment.

FIG. 13 is an enlarged schematic diagram of a dielectric layer between internal electrodes in the end margin region of a multilayer ceramic capacitor according to the second embodiment.

FIG. 14 is an enlarged schematic view of a cover dielectric layer of a multilayer ceramic capacitor according to the second embodiment.

FIG. 15A is a plan view illustrating an example of a lamination sheet in a manufacturing method of a multilayer ceramic capacitor according to the second embodiment.

FIG. 15B is a cross-sectional view taken along the line A-A of FIG. 15A.

FIG. 16 is a cross-sectional view illustrating an example of a laminated sheets body in a manufacturing method of a multilayer ceramic capacitor according to the second embodiment.

FIG. 17 is a flowchart illustrating an example of a manufacturing method of a multilayer ceramic capacitor according to the second embodiment.

FIG. 18 is a cross-sectional view illustrating an example of a laminate in a manufacturing method of a multilayer ceramic capacitor according to the second embodiment.

FIG. 19 is a cross-sectional view illustrating an example of an element body before firing in a method of manufacturing a multilayer ceramic capacitor according to the second embodiment.

### DETAILED DESCRIPTION

When the ceramic grains mainly composed of ceramic in the dielectric layers have a large grain size, the life of the dielectric layers is short due to dielectric breakdown or the like. On the other hand, when the ceramic grains have a small grain size, the strength of the dielectric layers is weak.

In the Patent Publication No. 2014-35384, the dielectric breakdown can be suppressed by making the grain size of the first region smaller than the grain size of the second region. However, in order to change the grain size of the ceramic grains in one dielectric layer, a complicated manufacturing process such as forming one dielectric layer using three green sheets is needed.

Referring to the drawings, embodiments will be described below by taking a multilayer ceramic capacitor as an example of a multilayer ceramic electronic component.

### Embodiment

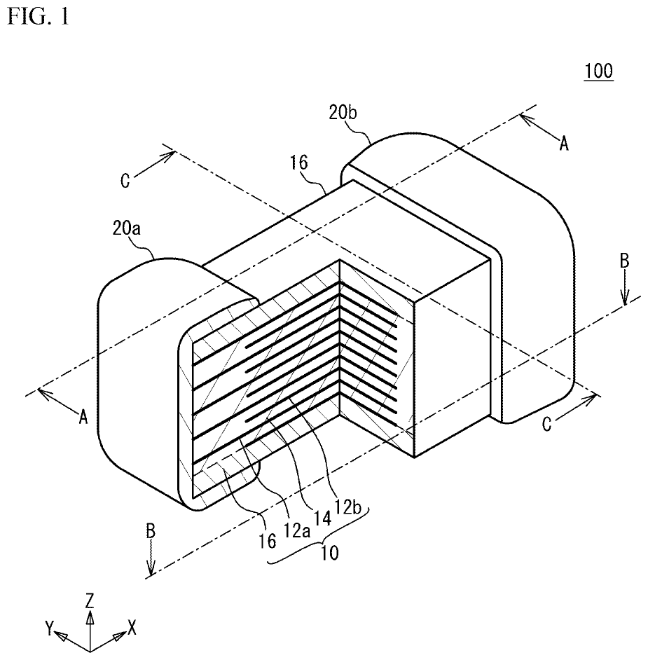

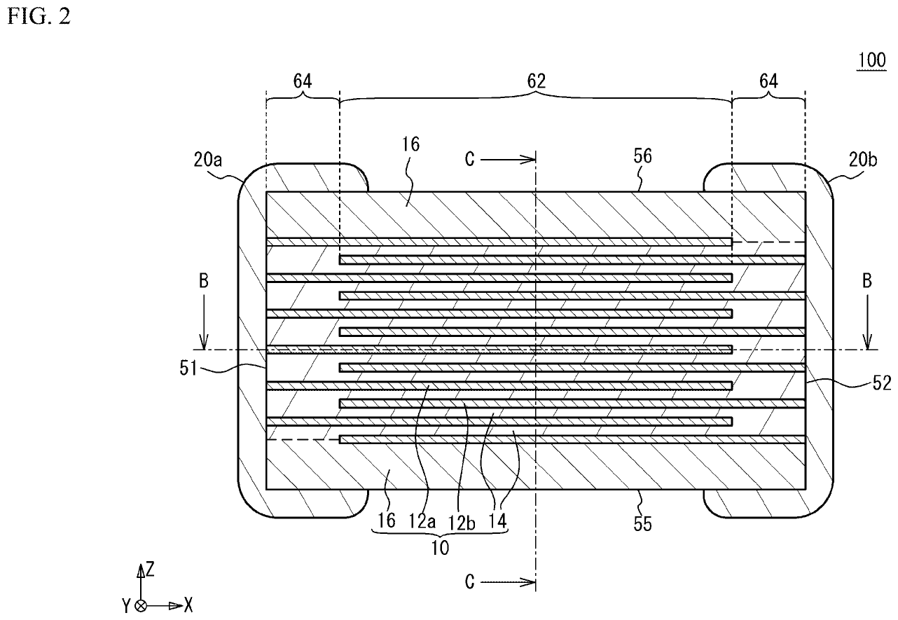

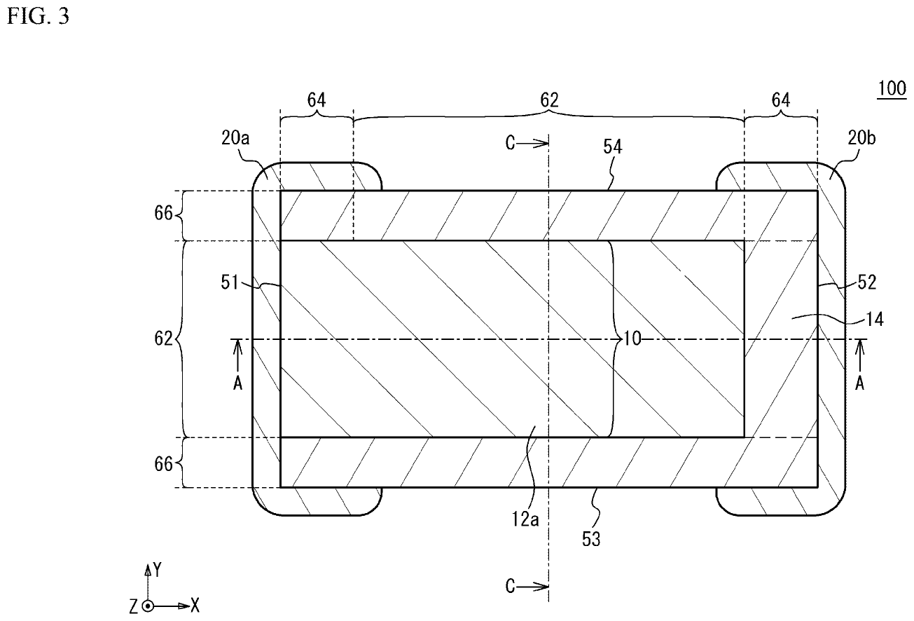

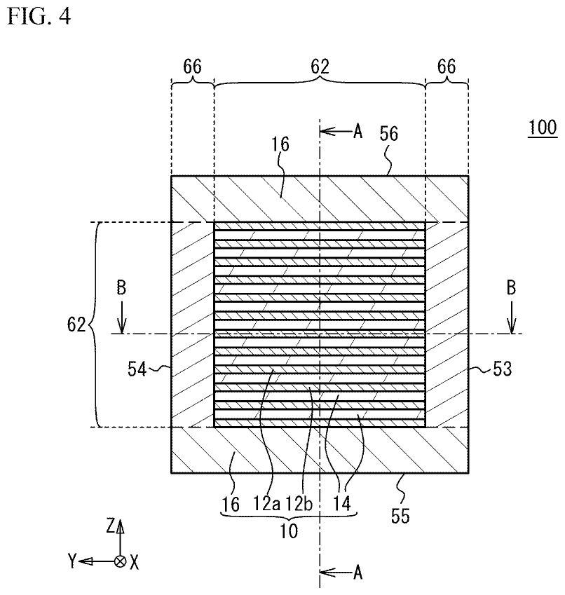

FIG. 1 is a partial cross-sectional perspective view of a multilayer ceramic capacitor 100 according to an embodiment. FIG. 2 is a cross-sectional view taken along the line A-A of FIG. 1. FIG. 3 is a cross-sectional view taken along the line B-B of FIG. 1. FIG. 4 is a cross-sectional view taken along the line C-C of FIG. 1.

In FIGS. 1 to 4, the Z direction (first direction) is a lamination direction in which dielectric layers 14 and internal electrodes 12a and 12b are laminated, and is a direction in which a lower surface 55 and an upper surface 56 of the element body 10 face each other. The X direction (second direction) is a length direction of the element body 10, and is a direction in which a pair of end surfaces 51 and 52 of the element body 10 face each other. The Y direction (third direction) is a width direction of the internal electrodes 12a and 12b, and is the direction in which a pair of side surfaces 53 and 54 of the element body 10 face each other. The X, Y, and Z directions intersect or are orthogonal to each other.

The multilayer ceramic capacitor 100 is provided with an element body 10 having a substantially rectangular parallelepiped shape, and external electrodes 20a and 20b. The element body 10 has the plurality of dielectric layers 14, the plurality of internal electrodes 12a and 12b, and a cover dielectric layer 16. The plurality of internal electrodes 12a (first internal electrode) and the plurality of internal electrodes 12b (second internal electrode) are alternately laminated. One of the dielectric layers 14 is provided between one of the internal electrodes 12a and one of the internal electrodes 12b. The outermost layers in the lamination direction (Z direction) of the laminate in which the dielectric layers 14 and the internal electrodes 12a and 12b are laminated are the internal electrodes 12a and 12b, and the lower surface and the upper surface of the laminate are covered with the cover dielectric layers 16. The cover dielectric layers 16 are located outermost in the Z direction.

The internal electrodes 12a and 12b are alternately drawn to the end surfaces 51 and 52. The internal electrode 12a is drawn to the end surface 51, and the internal electrode 12b is not drawn to the end surface 51. The internal electrode 12b is drawn to the end surface 52, and the internal electrode 12a is not drawn to the end surface 52. That is, the internal electrodes 12a and 12b are respectively connected to the different end surfaces 51 and 52.

The external electrode 20a is in contact with the internal electrode 12a drawn to the element body 10 at the end surface 51. The external electrode 20b is in contact with the internal electrode 12b drawn to the element body 10 at the end surface 51. The external electrode 20a covers the end surface 51, and also covers the end portions of side surfaces 53 and 54, the lower surface 55, and the upper surface 56 in the-X direction. The external electrode 20b is in contact with the internal electrode 12b at the end surface 52. The external electrode 20b covers the end surface 52, and also covers the end portions of the side surfaces 53 and 54, the lower surface 55, and the upper surface 56 in the +X direction.

As illustrated in FIGS. 2 and 3, a central portion of the element body 10 in the X direction as viewed in the Z direction is a capacitance section 62, in which the internal electrodes 12a and 12b overlap each other. End portions of the element body 10 in the X direction as viewed in the Z direction are end margin regions 64, in which one of the internal electrodes 12a and 12b is provided and the other of the internal electrodes 12a and 12b is not provided. As illustrated in FIGS. 3 and 4, a central portion of the element body 10 in the Y direction, in which the internal electrodes 12a and 12b face each other, is the capacitance section 62. End portions of the element body 10 in the Y direction are not provided with the internal electrodes 12a and 12b, and are referred to side margin regions 66.

The size of the multilayer ceramic capacitor 100 is, for example, a length (length in the X direction) of 0.25 mm, a width (width in the Y direction) of 0.125 mm, and a height (height in the Z direction) of 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes.

The thickness of the side margin region 66 is, for example, 10 μm to 30 μm. The length of the end margin region 64 in the X direction is, for example, 10 μm to 50 μm.

The internal electrodes 12a and 12b are mainly composed of a base metal such as nickel (Ni), copper (Cu), tin (Sn), or the like. As the internal electrodes 12a and 12b, a noble metal such as platinum (Pt), palladium (Pd), silver (Ag), or gold (Au), or an alloy containing these metals may be used. The thickness of the internal electrodes 12 a and 12 b is, for example, 0.1 μm or more and 1 μm or less.

The dielectric layers 14 have, for example, a ceramic material having a perovskite structure represented by the general formula ABO3 as a main phase. The perovskite structure contains ABO_{3-α}out of the stoichiometric composition. For example, the ceramic material can be selected from at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure. Ba_{1-x-y}CaₓSr_{y}Ti_{1-z}Zr_{z}O₃ is barium strontium titanate, barium calcium titanate, barium zirconium titanate, calcium zirconium titanate, barium calcium zirconium titanate, or the like. For example, the dielectric layer 14 contains 90 at% or more of the main component ceramic. The thickness of the dielectric layer 14 is, for example, 0.3 μm or more and 2 μm or less.

Additives may be added to the dielectric layers 14. Examples of additives to the dielectric layers 14 include oxides of zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm) and ytterbium (Yb)), oxides containing cobalt (Co), nickel (Ni), lithium (Li), boron (B), sodium (Na), potassium (K) or silicon (Si), or glasses containing cobalt, nickel, lithium, boron, sodium, potassium or silicon.

The composition of the main ceramic of the cover dielectric layers 16 may be the same as or different from that of the main ceramic of the dielectric layers 14.

The external electrodes 20a and 20b are mainly composed of a metal such as copper, nickel, aluminum (Al), or zinc (Zn), or an alloy of two or more of these metals (for example, an alloy of copper and nickel), and contain a ceramic such as a glass component for densification of the external electrodes 20a and 20b and a common material for controlling the sinterability of the external electrodes 20a and 20b. The glass component is an oxide such as barium (Ba), strontium (Sr), calcium (Ca), zinc, aluminum, silicon or boron. The common material is, for example, a ceramic component having the same material as the main component of the dielectric layer 14 as the main component. A plating film mainly composed of a base metal such as nickel, copper, or tin may be formed on the surfaces of the external electrodes 20a and 20b. Further, a film of a conductive resin such as an epoxy resin or a urethane resin may be formed on the surface of the plating film.

### First Embodiment

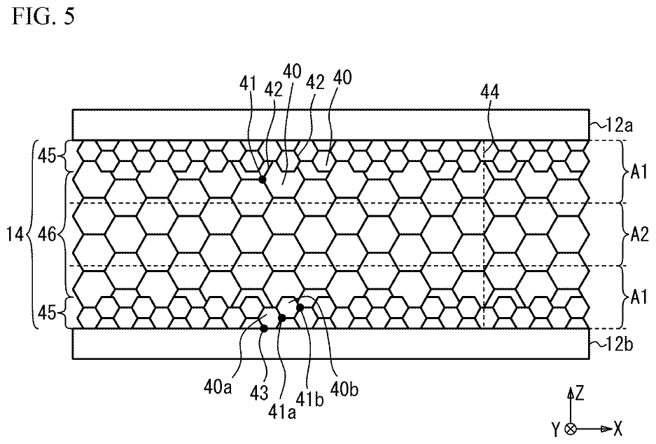

FIG. 5 is an enlarged schematic diagram of the dielectric layer 14 of the multilayer ceramic capacitor 100 according to the first embodiment. FIG. 5 is an enlarged schematic diagram of the dielectric layer 14 between the internal electrodes 12a and 12b in the capacitance section 62. In practice, the shape and grain size of ceramic grains 40 (hereinafter referred to as grains) in the dielectric layer 14 may vary, but in FIG. 5, the ceramic grains 40 are schematically illustrated as a hexagonal shape, the grain size of the ceramic grains 40 in outer regions 45 within the dielectric layer 14 is illustrated uniformly, and the grain size of the ceramic grains 40 in a central region 46 within the dielectric layer 14 is illustrated uniformly.

The dielectric layer 14 is covered with a plurality of grains 40 mainly composed of ceramic. The boundary of the ceramic grain 40 is a grain boundary 42. A triple point 41 is a point where three grains 40 are in contact with each other and a point where the three grain boundaries 42 intersect each other. When the grain size of the ceramic grains 40 increases, the number of the triple points 41 per unit area decreases. The pair of outer regions 45 are in contact with the internal electrodes 12a and 12b in the Z direction. The central region 46 is sandwiched between the outer regions 45 in the Z direction. The grain size of the ceramic grains 40 in the outer regions 45 is smaller than the grain size of the ceramic grains 40 in the central region 46. If the grain size of the outer regions 45 in contact with the internal electrodes 12a and 12b is large, dielectric breakdown is likely to occur, and the life is short. On the other hand, if the grain diameter of the ceramic grains 40 in the central region 46 is small, the strength is insufficient, the dielectric constant is small, and the multilayer ceramic capacitor 100 is larger. Therefore, the grain diameter of the ceramic grains 40 in the central region 46 is greater than the grain diameter of the outer regions 45. Thus, the dielectric breakdown of the multilayer ceramic capacitor 100 is suppressed to prolong the life thereof, and the strength is improved to increase the dielectric constant, thereby making it possible to miniaturize the multilayer ceramic capacitor 100.

In order to form a plurality of regions having different grain sizes in one dielectric layer 14, it is conceivable to form the one dielectric layer 14 from a plurality of green sheets having different particle sizes, for example. However, it is difficult to make each green sheet thin. In addition, the manufacturing process is complicated.

### Manufacturing Method of Multilayer Ceramic Capacitor of First Embodiment

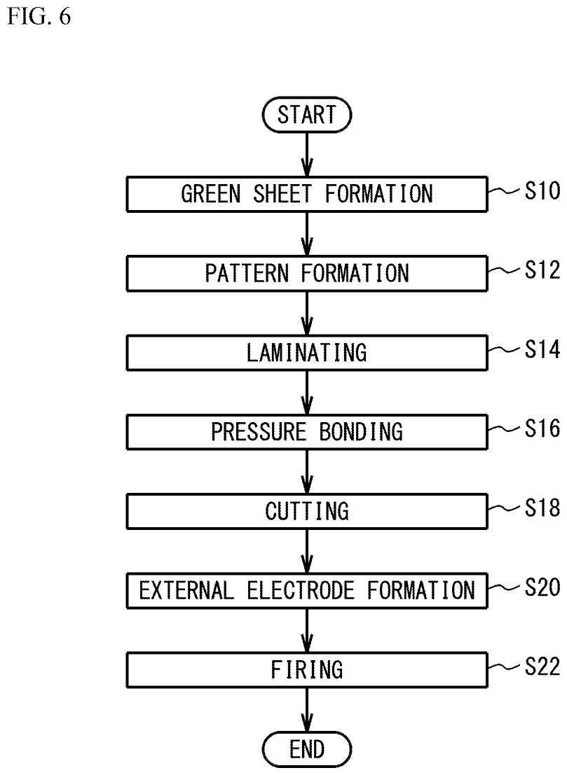

A manufacturing method of the multilayer ceramic capacitor 100 is described below. FIG. 6 is a flowchart illustrating an example of the manufacturing method of the multilayer ceramic capacitor 100 according to the first embodiment.

### Green Sheet Formation Process

First, a green sheet 30 is formed (process S10). In the process S10, for example, a dielectric material is prepared by adding various additive compounds (sintering aid, etc.) to ceramic powder such as barium titanate. Phosphorus is not added to the dielectric material. A binder, an organic solvent such as ethanol or toluene, and a plasticizer are added to the prepared dielectric material and wet mixed to form a slurry. The binder is an organic binder such as polyvinyl butyral (PVB) resin, acrylic resin, or cellulosic resin. The produced slurry is applied on a substrate to form the green sheet 30 by, for example, a die coater method or a doctor blade method. The substrate is, for example, a PET (polyethylene terephthalate) film. Thereafter, the green sheet 30 is dried. A green sheet 31 for the cover dielectric layers 16 is formed in the same manner as the green sheet 30.

### Pattern Formation Process

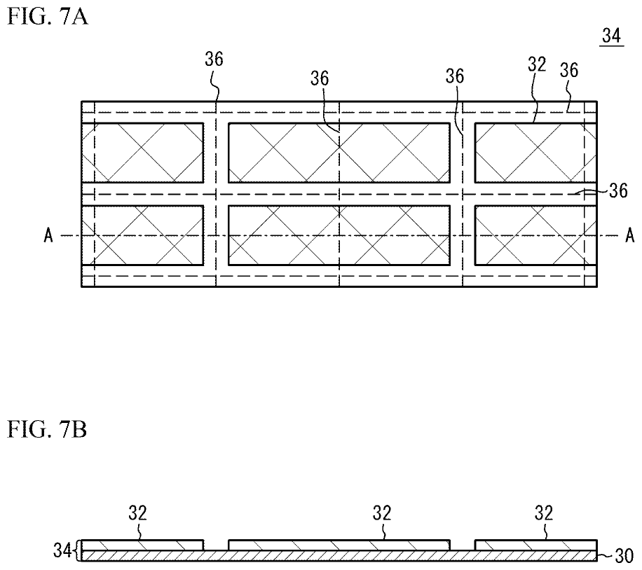

Subsequently, metal patterns 32 are formed on the green sheets 30 and 31 (process S12). FIG. 7A is a plan view illustrating an example of a lamination sheet 34 in the manufacturing method of the multilayer ceramic capacitor 100 according to the first embodiment, and FIG. 7B is a cross-sectional view taken along the line A-A of FIG. 7A. Cutting lines 36 in FIG. 7A are used for cutting a laminated sheets body 35 in the process S18.

In the process S12, first, metal paste containing metal powder such as nickel powder, a phosphorus compound, an organic binder, and an organic solvent is prepared. The phosphorus compound is, for example, a phosphoric acid, a phosphate compound or a phosphoric acid compound. The metal paste may include ceramic particles as a common material. As illustrated in FIGS. 7A and 7B, the metal paste is printed on the green sheet 30 using, for example, a gravure printing method to form the metal patterns 32. Thus, the lamination sheet 34 in which the metal patterns 32 are formed on the green sheet 30 is formed. To form lamination sheet 34a for the cover dielectric layers 16, the metal patterns 32 are formed on the green sheet 31 in the same manner as the green sheet 30.

### Laminating Process

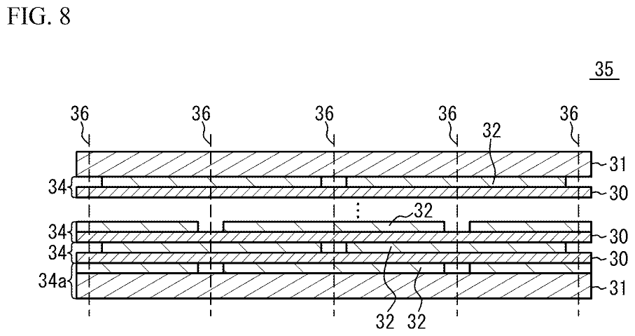

Subsequently, the green sheets 30 and 31 are laminated (process S14). FIG. 8 is a cross-sectional view illustrating an example of the laminated sheets body 35 in the manufacturing method of the multilayer ceramic capacitor 100 according to the first embodiment, and corresponds to the cross-section taken along the line A-A in FIG. 7A. In the process S14, the plurality of lamination sheets 34 are laminated on the lamination sheet 34a, and then the green sheet 31 for the cover dielectric layer 16 is laminated. Thus, the laminated sheets body 35 in which the lamination sheet 34a and the plurality of lamination sheets 34 are laminated is formed.

### Pressure Bonding Process

Subsequently, the laminated sheets body 35 is pressure-bonded (process S16). In the process S16, the laminated sheets body 35 formed in the process S14 is pressed to crimp the plurality of lamination sheets 34a and 34. As the pressure bonding means, for example, a hydrostatic press is used.

### Cutting Process

Subsequently, the laminated sheet body 35 is cut (step S18). In the process S18, the laminated sheets body 35 is cut along the predetermined cutting line 36 in the lamination direction by a cutting blade to obtain a plurality of element bodies 10. After the process S18, the element body 10 may be polished by a technique such as barrel polishing. Thus, the corner portion of the element body 10 is rounded.

### External Electrode Formation Process

Subsequently, the external electrodes 20a and 20b are formed (process S20). In the process S20, conductive paste containing, for example, metal powder, glass frit, binder, and solvent are applied on the end surfaces 51 and 52. After the conductive paste is applied, the base metal layers of the external electrodes 20a and 20b are formed by baking. The binder and the solvent evaporate by the baking. The conductive paste is applied by, for example, a dip method.

### Firing Process

Subsequently, the element body 10 is fired (process S22). In the process S22, the element body 10 is debinded in a nitrogen gas atmosphere at 250° C. to 500° C., and then fired in a reducing atmosphere at 1300° C. to 1400° C. Thus, the respective particles in the element body 10 are sintered. After the process S22, a plated metal layer may be formed on the surface of the base metal layers of the external electrodes 20a and 20b by plating.

The external electrodes 20a and 20b may be formed before the firing process S22, and the external electrodes 20a and 20b may be baked in the firing process. In the cutting process S18, the metal pattern 32 may be exposed from the side surface of the laminate in the Y direction, and side green sheets may be formed on the side surfaces of the laminate.

In the debinding treatment in the firing process S22, phosphorus in the metal pattern 32 diffuses into the green sheet 30. The phosphorus increases decomposition temperature of resin such as binder contained in the green sheet 30. Thus, when the phosphorus concentration is high, the carbon derived from the resin tends to remain at the boundary of the ceramic powder. Therefore, sintering of the ceramic powder is suppressed. Consequently, the grain size of the ceramic grains 40 is reduced. This is based on the knowledge of the inventors.

In FIG. 5, the place where the phosphorus is mainly distributed is a vicinity of a portion 43 in contact with the internal electrode 12a or 12b and the grain boundary 42, a vicinity of a triple point 41a of a ceramic grain 40a in contact with the internal electrode 12a or 12b, and a vicinity of a triple point 41b of a ceramic grain 40b which is not in contact with the internal electrode 12a and 12b and is adjacent to the ceramic grain 40a in contact with the internal electrode 12a or 12b. Thus, the phosphorus present at the triple points 41a and 41b inhibits the sintering of the dielectric. Therefore, the grain sizes of the ceramic grains 40a and 40b are not greater than those of the other grains 40.

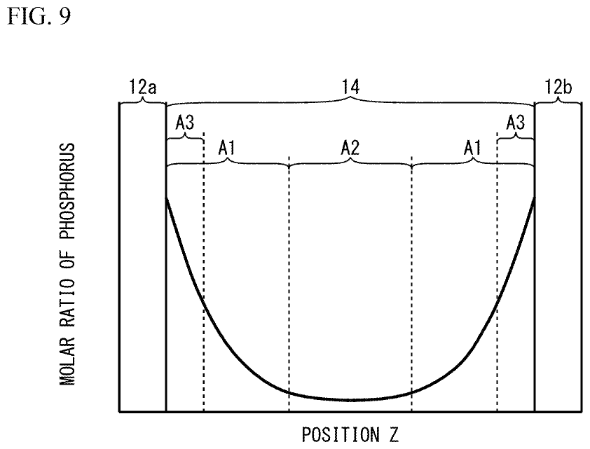

FIG. 9 is a schematic diagram illustrating a characteristic of the molar ratio of phosphorus with respect to the position Z in the dielectric layer 14 in the capacitance section 62. The horizontal axis of FIG. 9 is the position Z in the Z direction. The vertical axis is the molar ratio of phosphorus. The molar ratio of phosphorus is a molar ratio of phosphorus to the main component metal element of the ceramic in the dielectric layer 14. For example, when the main component of the ceramic in the dielectric layer 14 is barium titanate, the main component metal element is titanium or barium. Thus, the molar ratio is defined by a molar ratio of phosphorus to titanium or a molar ratio of phosphorus to barium.

As illustrated in FIG. 9, the molar ratio of phosphorus at the boundary between the internal electrodes 12a and 12b and the dielectric layer 14 is high. The phosphorus molar ratio decreases with increasing distance from the internal electrodes 12a and 12b. The molar ratio of phosphorus near the center of the dielectric layer 14 is the lowest.

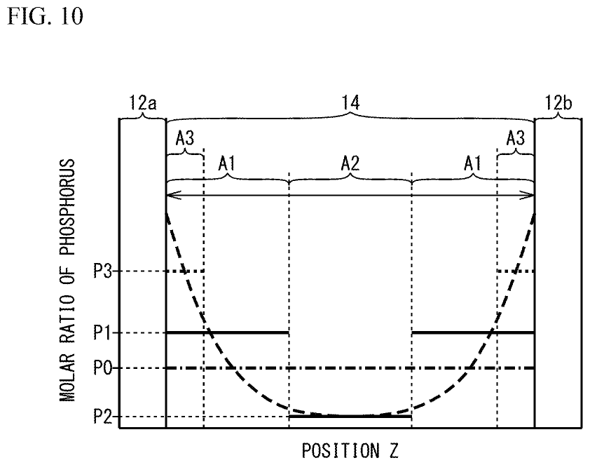

FIG. 10 is a schematic diagram illustrating an average of the molar ratio of phosphorus in each region in the dielectric. In FIG. 10, the dotted line indicates the molar ratio of phosphorus in the dielectric layer 14 of FIG. 9. As illustrated in FIG. 5, one dielectric layer 14 in the capacitance section 62 is virtually divided at equal intervals in the lamination direction into three regions having a pair of first regions A1 in contact with the internal electrodes 12a and 12b and a second region A2 sandwiched between the pair of first regions A1. At this time, the first molar ratio P1 of phosphorus to the main component metal element of the ceramic in the pair of first region A1 is greater than the second molar ratio P2 of phosphorus to the main component metal element in the second region A2.

The first molar ratio P1 is preferably 1.2 times or more the second molar ratio P2, and is more preferably 1.5 times or more the second molar ratio P2. The first molar ratio P1 is, for example, 0.002 or more and 0.02 or less (0.2% or more and 2% or less). The second molar ratio P2 is, for example, 0.001 or more and 0.01 or less (0.1% or more and 1% or less).

Since the first molar ratio P1 is higher than the second molar ratio P2, the grain size W1 (first grain size) of the ceramic grains 40 in the dielectric layer 14 in the first region A1 is smaller than the grain size W2 (second grain size) of the ceramic grains 40 in the dielectric layer 14 in the second region A2. This can improve the life. On the other hand, since the grain size W4 of the ceramic grains 40 is large, a high dielectric constant can be obtained. Further, in FIGS. 7A and 7B, since the structure illustrated in FIG. 5 can be realized by adding phosphorus to the metal pattern 32, the complication of the manufacturing process can be suppressed. The grain size W1 is preferably 1.2 times or more the grain size W2, and more preferably 1.5 times or more the grain size W2. The grain size W1 is, for example, 80 nm or more and 500 nm or less. The grain diameter W2 is, for example, 100 nm or more and 1 μm or less.

Phosphorus is distributed in the vicinity of the internal electrodes 12a and 12b. Therefore, as illustrated in FIG. 5, in the dielectric layer 14, the grain size W3 (third grain size) of the ceramic grain 40b, which is not adjacent to the internal electrodes 12a and 12b and is adjacent to the ceramic grain 40a in contact with the internal electrode 12a or 12b, is smaller than the grain size W2 of the ceramic grain 40 in the second region A2. The grain size W3 of the ceramic grains 40 b is preferably 0.8 times or less the grain size W2 of the ceramic grains 40 in the second region A2, more preferably 0.5 times or less the grain size W2 of the ceramic grains 40 in the second region A2.

In FIG. 10, the third molar ratio P3 of phosphorus to the main component metal element in a pair of third regions A3, each range of which is 0.1 times a width W0 of the dielectric layer 14 in the Z direction from a pair of the internal electrodes 12a and 12b adjacent to the dielectric layer 14, is 1.5 times or more a fourth molar ratio P0 of phosphorus to the main component metal element in the entire dielectric layer 14. The third molar ratio P3 is preferably twice or more the fourth molar ratio P0, and more preferably three times or more the fourth molar ratio P0.

As a number of the ceramic grains 40 arranged in the Z direction of the dielectric layer 14 is smaller, the distribution of the phosphorus molar ratio in the Z direction in the dielectric layer 14 is nearer to uniform. Therefore, the number of ceramic grains 40 overlapping a straight line 44 in the dielectric layer 14 in FIG. 5 (i.e., the number of ceramic grains 40 in the Z direction of the dielectric layer 14) is preferably five or more, more preferably seven or more, and still more preferably ten or more. From the viewpoint of not lowering the dielectric constant of the dielectric layer 14, the number of the ceramic grains 40 in the Z direction of the dielectric layer 14 is 20 or less.

In order to diffuse phosphorus into the dielectric layer 14, the molar ratio of phosphorus to the main component metal element in the metal pattern 32 in FIGS. 7A and 7B is preferably 0.0003 or more and 0.003 or less (0.03% or more and 0.3% or less). Additionally, the firing temperature in the firing process S22 is preferably 1500° C. or lower, and more preferably 950° C. or more and 1300° C. or less.

The diffusion of phosphorus from the internal electrodes 12a and 12b into the dielectric layer 14 occurs mainly when the main component of the ceramic of the dielectric layer 14 is barium titanate and the main component of the internal electrodes 12a and 12b is nickel.

Thus, according to the manufacturing method of the first embodiment, since the grain size of the ceramic grains 40 in the first to third regions A1 to A3 and the molar ratio of phosphorus are adjusted by diffusing phosphorus from the metal pattern 32 into the dielectric layer 14, the manufacturing process can be simplified as compared with, for example, a complicated manufacturing process of forming one dielectric layer 14 from a plurality of green sheets having different grain sizes of the ceramic particles.

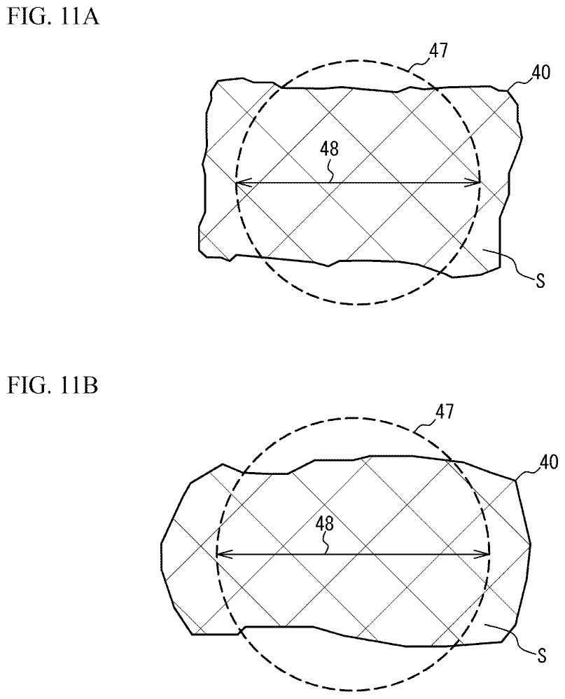

FIGS. 11A and 11B are diagrams illustrating examples of methods for measuring the grain size. As illustrated in FIGS. 11A and 11B, the cross sections of the dielectric layer 14 and the cover dielectric layer 16 are observed using an electron microscope. Calculation of an area S of the ceramic grain 40 is performed. Assuming a circle 47 with the area S, a diameter 48 (Heywood diameter) of the circle 47 is defined as a grain size W of the ceramic grain 40. That is, the grain diameter W is represented as W=2 (S/π)^{1/2}, where S is the area of the ceramic grain 40.

The grain sizes W1 and W2 in the first and second regions A1 and A2 are respectively defined as follows. As shown in FIG. 5, for example, in an electron microscope image, the straight line 44 extending in the Z direction to cross the first and second regions A1 and A2 is drawn. The grain sizes W of all the ceramic grains 40 which overlap the straight line 44 in the first region A1 and do not overlap the second region A2 are measured. The number of grains 40 for measuring the grain sizes W is set to be 10 to 100. When the number of grains 40 for measuring the grain sizes W is less than 10, an additional straight line to the straight line 44 is drawn so as to measure the grain sizes W of the ceramic grains 40 overlapping the additional straight line. The median of the measured grain sizes W of the ceramic grains 40 is defined as the grain size W1. As for the grain size W2, all the grain sizes W of the ceramic grains 40 which overlap the straight line 44 in the second region A2 and do not overlap the first region A1 are measured by the electron microscope image. The grain sizes W of 10 to 100 grains 40 are measured in the same manner as the grain size W1, and the median value of the grain sizes W is defined as the grain size W2. As for the grain size W3 of the ceramic grains 40b, for example, the grain sizes W of 10 to 20 grains 40 b as targets within the electron microscope image are measured, and the median value of the measured grain sizes W is defined as the grain size W3.

The molar ratio of phosphorus to the main component metal element of the ceramic is measured by, for example, an inductively coupled plasma optical emission spectroscopy method, an energy dispersive X-ray spectroscopy method, or an electron beam microanalyzer method. For example, the region where phosphorus exists is examined by using the energy dispersive X-ray spectroscopy or the electron beam microanalyzer method, and the molarity of phosphorus and the molarity of the main component metal element in the region are measured by using the inductively coupled plasma optical emission spectroscopy. The molar ratio of phosphorus is calculated by the molarities. The molar ratio in the first to third regions A1 to A3 is determined by setting a straight line (for example, the straight line 44 in FIG. 5) crossing the first to third regions A1 to A3 in the Z direction, and the molar ratio of the portion overlapping the straight line is averaged in the first to third regions A1 to A3.

The number of the ceramic grains 40 in the Z direction can be defined by, for example, setting the straight line 44 extending in the Z direction in the dielectric layer 14 in the electron microscope image and counting the number of the ceramic grains 40 through which the straight line 44 passes. The number of grains 40 in the Z direction may be specified by setting straight lines at five or more different locations and averaging the number of grains passing through each of the straight lines.

### Second Embodiment

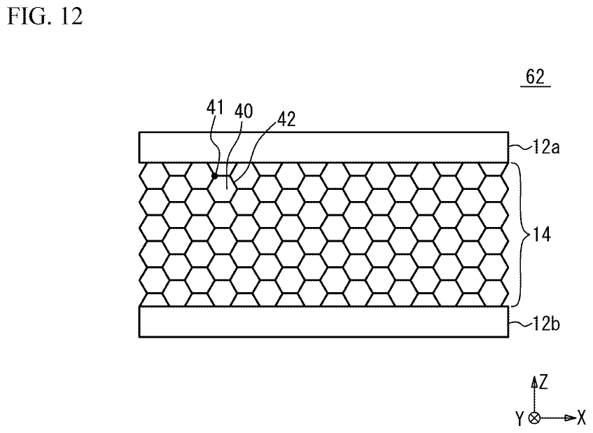

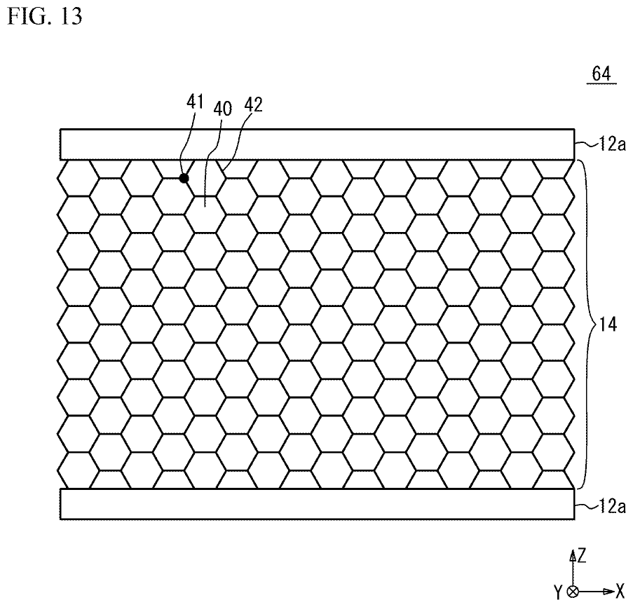

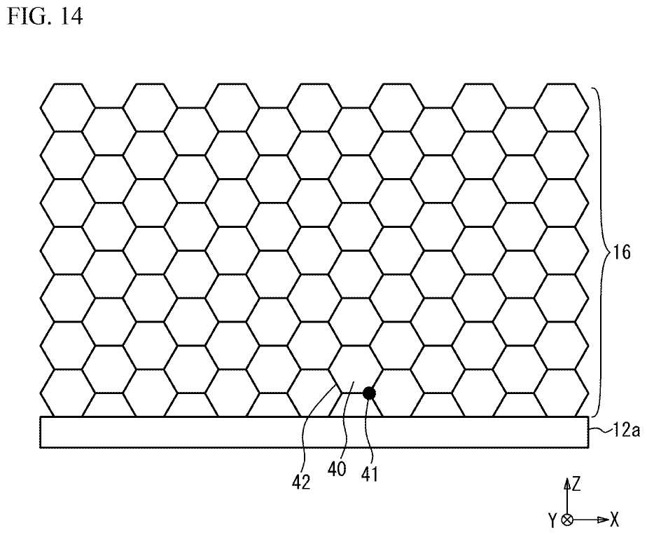

FIG. 12 is an enlarged schematic view of the dielectric layer 14 between the internal electrodes 12a and 12b in the capacitance section 62 of the multilayer ceramic capacitor according to the second embodiment. FIG. 13 is an enlarged schematic diagram of the dielectric layer 14 between the internal electrodes 12a in the end margin region 64 of the multilayer ceramic capacitor according to the second embodiment. FIG. 14 is an enlarged schematic view of the cover dielectric layer 16 of the multilayer ceramic capacitor according to the second embodiment. In FIGS. 12 to 14, components in common with those in FIG. 5 are given the same reference numerals as those in FIG. 5, and the descriptions thereof are omitted. In FIGS. 12 to 14, the ceramic grains 40 are schematically illustrated as a hexagonal shape and are the grain sizes of the grains are illustrated uniformly in the same manner as those in FIG. 5.

The dielectric layer 14 and the cover dielectric layer 16 are packed with a plurality of grains 40 mainly composed of ceramic. As the grain sizes of the ceramic grains 40 are greater, the number of triple points 41 per unit area is smaller. As the grain sizes of the ceramic grains 40 are greater, dielectric breakdown in the dielectric layer is more likely to occur, thus shortening the lifetime. Additionally, as the grain sizes of the ceramic grains 40 is greater, the strength of the dielectric layer 14 is greater. A large amount of phosphorus is distributed, for example, in the vicinity of the triple point 41 of the dielectric layer 14.

The molar ratio of phosphorus to the main component metal element of the ceramic in the dielectric layer 14 in the capacitance section 62 is represented as P1 (first molar ratio or fifth molar ratio), and the grain size of the ceramic grains 40 in the dielectric layer 14 in the capacitance section 62 is represented as W1 (first grain size). The molar ratio of phosphorus to the main component metal element in the dielectric layer 14 in the end margin region 64 is represented as P2 (second molar ratio or sixth molar ratio), and the grain size of the ceramic grains 40 in the dielectric layer 14 in the end margin region 64 is represented as W2 (second grain size). The molar ratio of phosphorus to the main component metal element of the ceramic in the cover dielectric layer 16 is represented as P3 (third molar ratio), and the grain size of the ceramic grains 40 in the cover dielectric layers 16 is represented as W3 (third grain size). The molar ratio of phosphorus to the main component metal element of the ceramic in the side margin regions 66 is represented as P4 (fourth molar ratio), and the grain size of the ceramic grains 40 in the side margin regions 66 is represented as W4 (fourth grain size).

The first to fourth molar ratios P1 to P4 satisfy the relationship of P1>P2, P1>P3, and P1>P4. The grain sizes W1 to W4 satisfy the relationship of W1<W2, W1<W3 and W1<W4. For example, when the main component of the ceramic in the dielectric layer 14 is barium titanate, the main component metal elements of the ceramic are titanium and barium. Thus, the phosphorus ratio is defined by the molar ratio of phosphorus to titanium or the molar ratio of phosphorus to barium.

In the end margin region 64, the distance between the internal electrodes 12a is long, and voltage is uniformly applied to the internal electrodes 12a. Therefore, dielectric breakdown is unlikely to occur. In the capacitance section 62, the distance between the internal electrodes 12a and 12b is short, and different voltages are applied to the internal electrodes 12a and 12b. Therefore, dielectric breakdown is likely to occur. Accordingly, the relationship between the grain sizes satisfies W1<W2. Thus, dielectric breakdown is less likely to occur in the capacitance section 62. On the other hand, in the end margin region 64, since dielectric breakdown does not easily occur, the influence of the grain size is small even though the grain size W2 is great. Thus, the grain size W2 can be increased to strengthen the dielectric layer 14. Also, almost no voltage is applied to the cover dielectric layers 16 and the side margin regions 66. Therefore, the relationship between the grain sizes satisfies W1<W3 and W1<W4. This can increase the strength of the cover dielectric layers 16 and the side margin regions 66. In the end, the element body 10 can be strengthened by increasing the strength of the cover dielectric layers 16, the end margin regions 64, and the side margin regions 66.

### First Example of Manufacturing Method of Multilayer Ceramic Capacitor According to Second Embodiment

The first example of a manufacturing method of the multilayer ceramic capacitor 100 according to the second embodiment is described hereinafter. Since the flow of the manufacturing method of this example is the same as that of the first embodiment, FIG. 6 is referred to in the following description.

### Green Sheet Formation Process

First, the green sheet 30 is formed (process S10). In the process S10, for example, a dielectric material is prepared by adding a phosphorus compound and various additive compounds (sintering aid and the like) to a ceramic powder such as barium titanate. The phosphorus compound is, for example, a phosphoric acid, a phosphate compound or a phosphoric acid compound. A binder, an organic solvent such as ethanol or toluene, and a plasticizer are added to the prepared dielectric material and wet mixed to form a slurry. The binder is an organic binder such as polyvinyl butyral (PVB) resin, acrylic resin, or cellulosic resin. The produced slurry is applied on the substrate to form the green sheet 30 by, for example, a die coater method or a doctor blade method. The substrate is, for example, a PET (polyethylene terephthalate) film. Thereafter, the green sheet 30 is dried.

In the same manner as described above, the green sheet 31 for the cover dielectric layers 16 is formed. The dielectric material for the green sheet 31 is doped with a phosphorus compound or is undoped. The molar ratio M3 of phosphorus to the main component element of the ceramic particles of the green sheet 31 is lowered than the molar ratio M1 of phosphorus to the main component element of the ceramic particles of the green sheet 30. The molar ratio M1 of phosphorus to the main component element of the ceramic particles of the green sheet 30 is, for example, 0.002 or more and 0.02 or less (0.2% or more and 2% or less). The molar ratio M3 of phosphorus to the main component element of the ceramic particles of the green sheet 31 is, for example, approximately 0%. The molar ratio M1 is preferably twice or more the molar ratio M3, is more preferably 10 times or more the molar ratio M3, and is still more preferably 100 times or more the molar ratio M3.

### Pattern Formation Process

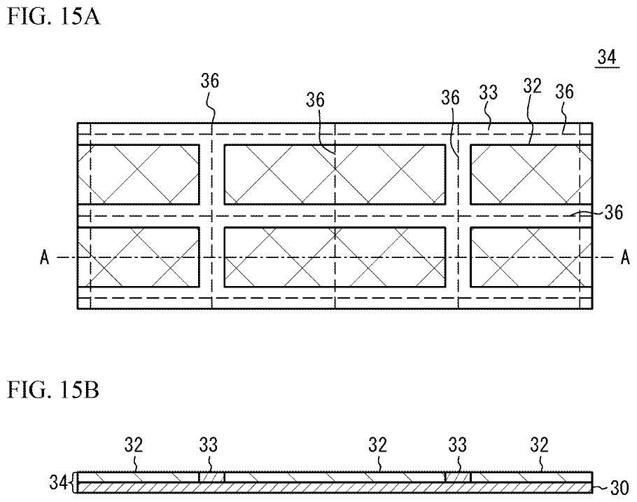

Subsequently, the metal pattern 32 and dielectric patterns 33 are formed on the green sheet 30 or 31 (process S12). FIG. 15A is a plan view illustrating an example of the lamination sheet 34 in the manufacturing method of the multilayer ceramic capacitor 100 according to the second embodiment, and FIG. 15B is a cross-sectional view taken along the line A-A of FIG. 15A. The cutting lines 36 in FIG. 15A are used for cutting the laminated sheets body 35 in the process S18.

In the process S12, first, a metal paste containing metal powder such as nickel powder, an organic binder, and an organic solvent is prepared. The metal paste may include ceramic particles as a common material. As illustrated in FIGS. 15A and 15B, the metal paste is printed on the green sheet 30 using, for example, a gravure printing method to form the metal patterns 32.

Next, dielectric paste containing ceramic powder such as sodium titanate powder, an organic binder, an organic solvent, and a plasticizer is prepared. A phosphorus compound may be or may not be added to the dielectric paste. The dielectric paste is printed on the green sheet 30 by, for example, the gravure printing method to form the dielectric patterns 33. The dielectric patterns 33 are inverse patterns of the metal patterns 32, and preferably almost no gap is formed between the dielectric patterns 33 and the metal patterns 32. Thus, suppression of steps between the capacitance section 62 and the end margin region 64 is possible after the firing. The molar ratio M2 of phosphorus to the main component metal element of the ceramic particles in the dielectric patterns 33 is, for example, approximately 0%, and is smaller than the molar ratio M1 of phosphorus to the main component metal element of the ceramic particles in the green sheet 30. The molar ratio M1 is preferably twice or more the molar ratio M2, is more preferably 10 times or more the molar ratio M2, and is still more preferably 100 times or more the molar ratio M2.

Thus, the lamination sheet 34 having the metal patterns 32 and the dielectric patterns 33 formed on the green sheet 30 is formed. Similarly to the green sheet 30, the metal patterns 32 and the dielectric patterns 33 are formed on the green sheet 31 for the cover dielectric layers 16 to form the lamination sheet 34a.

### Laminating Process

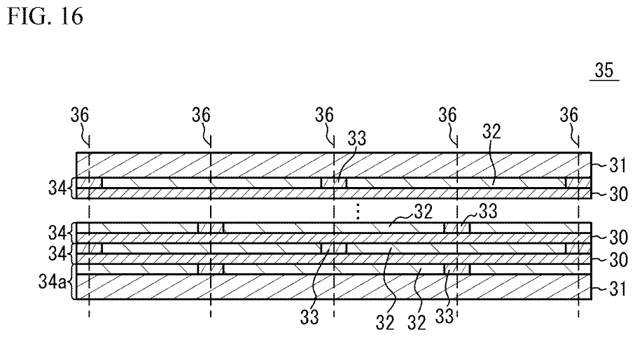

Subsequently, the green sheets 30 and 31 are laminated (process S14). FIG. 16 is a cross-sectional view illustrating an example of the laminated sheets body 35 in the manufacturing method of the multilayer ceramic capacitor 100 according to the second embodiment, and corresponds to the cross-section taken along line A-A in FIG. 15A. In the process S14, the plurality of lamination sheets 34 are laminated on the lamination sheet 34a, and then the green sheet 31 for the cover dielectric layer 16 is laminated. Thus, the laminated sheets body 35 in which the lamination sheet 34a and the plurality of lamination sheets 34 are laminated is formed.

Thereafter, the process S16 of pressure bonding, the process S18 of cutting, the process S20 of forming the external electrode, and the process S22 of firing are performed similarly to the first embodiment. As described above, in the firing process, phosphorus increases the decomposition temperature of the resin such as the binder contained in the green sheets 30 and 31 and the dielectric paste. Thus, when the molar ratio of phosphorus is high, carbon derived from the resin tends to remain at the boundary of the ceramic powder. Therefore, sintering of the ceramic powder is suppressed. Consequently, the grain size of the ceramic grains 40 is reduced. This is based on the knowledge of the inventors.

The molar ratio M1 of phosphorus in the green sheet 30 is greater than the molar ratio M3 of phosphorus to the main component metal element of the ceramic particles in the green sheet 31 (that is, the outermost green sheet in the element body). Therefore, after the firing, the molar ratio P1>P3 and the grain size W1<W3 are satisfied.

When the phosphorus molar ratio M2 of the dielectric pattern 33 and the phosphorus molar ratio M3 of the green sheet 31 are substantially equal to each other, the dielectric layer 14 in the end margin region 64 is formed of the green sheet 30 with a greater value of the phosphorus molar ratio M1 and the dielectric pattern 33 with a smaller value of the phosphorus molar ratio M2. On the other hand, the cover dielectric layer 16 is formed of the green sheet 31 with a smaller value of the phosphorus molar ratio M3. Therefore, after the firing, the molar ratio P2>P3 and the grain size W2<W3 are satisfied. Also, the side margin region 66 is formed of the green sheet 30. Therefore, the first molar ratio P1 and the fourth molar ratio P4 are substantially equal to each other, and the grain sizes W1 and W4 are substantially equal to each other. Thus, P4≤P2 is satisfied.

### Second Example of the Manufacturing Method of the Multilayer Ceramic Capacitor according to the Second Embodiment

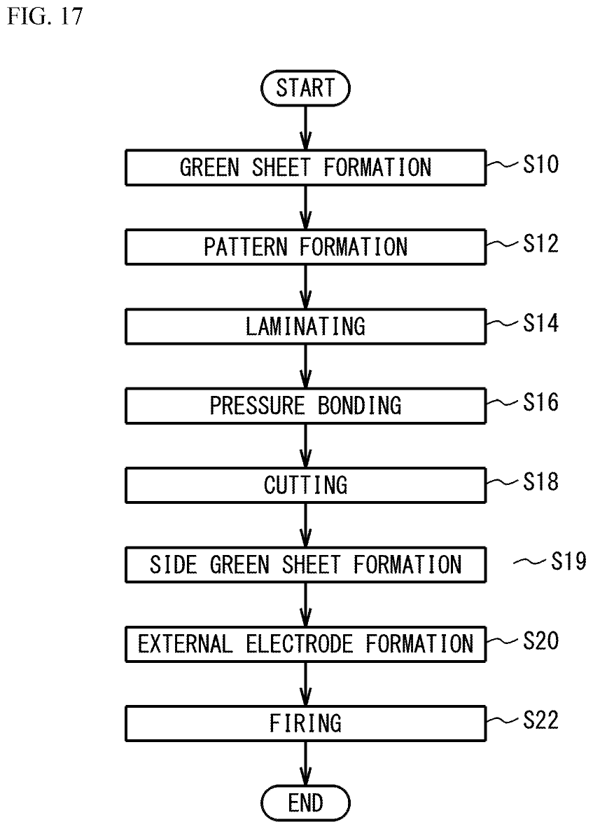

A second example of the manufacturing method of the multilayer ceramic capacitor 100 according to the second embodiment is described hereinafter. FIG. 17 is a flowchart illustrating the second example of the manufacturing method of the multilayer ceramic capacitor according to the second embodiment. As illustrated in FIG. 17, the processes S10 to S18 are the same as those in FIG. 6.

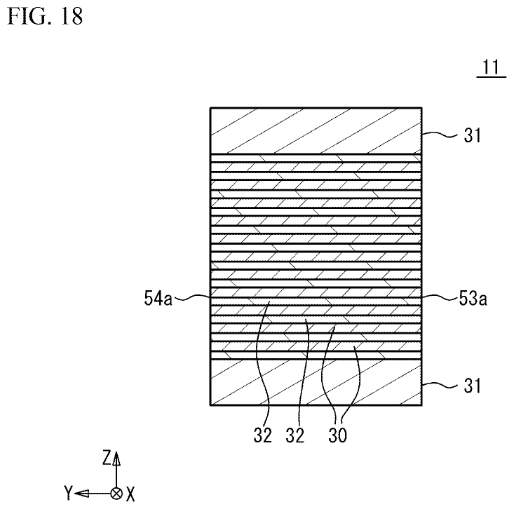

FIG. 18 is a cross-sectional view illustrating an example of a laminate 11 in the manufacturing method of the multilayer ceramic capacitor 100 according to the second embodiment. FIG. 18 corresponds to the cross section taken along the lines B-B in FIGS. 2 to 4 after the process S18. The metal patterns 32 are exposed from side surfaces 53a and 54a of the laminate 11 in which the green sheets 30 and 31 and the metal patterns 32 are laminated.

### Attaching Side Green Sheet

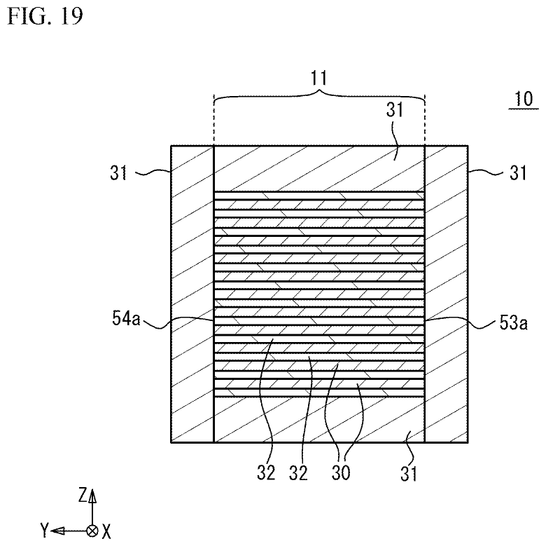

After the process S18, the side green sheets are attached to form the element body 10 before firing (process S19). FIG. 19 is a cross-sectional view illustrating an example of the element body 10 before firing in the manufacturing method of the multilayer ceramic capacitor 100 according to the second embodiment. In the process S19, a side surface 53a of the laminate 11 is pressed against the green sheet 31 prepared for the side margin region 66, thereby bonding the green sheet 31 to the side surface 53a. Similarly, the green sheet 31 is adhered to the side surface 54a of the laminate 11. The green sheet 31 has no phosphorus added thereto, or the molar ratio M3 of phosphorus is lower than the molar ratio M1 of phosphorus of the green sheet 30. Thereafter, the process S20 of forming the external electrodes 20a and 20b is performed.

### Firing Process

Subsequently, the firing process is performed (process S22). Thus, the side margin regions 66 are formed from the green sheets 31 adhered to the side surfaces 53a and 54a. Thereafter, the same process as that of S22 in FIG. 6 is performed.

In the multilayer ceramic capacitor manufactured by the manufacturing method of the present example, the phosphorus molar ratio M3 of the green sheets 31 attached to the side surfaces 53a and 54 before the firing process is lower than the phosphorus molar ratio M1 of the green sheet 30. Therefore, after the firing process, the molar ratio P1>P4 and the grain size W1<W4 are satisfied. When the phosphorus molar ratio M2 of the dielectric pattern 33 and the phosphorus molar ratio M3 of the green sheet 31 are substantially equal to each other, the dielectric layer 14 in the end margin region 64 is formed of the green sheet 30 with a greater value of the phosphorus molar ratio M1 and the dielectric pattern 33 with a smaller value of phosphorus molar ratio M2. On the other hand, the side margin region 66 is formed of the green sheet 31 with a smaller value of the phosphorus molar ratio M3. Therefore, after the firing, the molar ratio P2>P4 and the grain size W2<W4 are satisfied.

### Third Example of the Manufacturing Method of the Multilayer Ceramic Capacitor according to the Second Embodiment

The third example of the manufacturing method of the multilayer ceramic capacitor 100 according to the second embodiment is described hereinafter. The manufacturing flow of the multilayer ceramic capacitor 100 is the same as that of FIG. 6 or 17. No phosphorus compound is added to the green sheets 30 and 31 in the process S10 and the dielectric pattern 33 in the process S12. The phosphorus compound is added to the metal patterns 32 in the process S12. The phosphorus compound is, for example, a phosphoric acid, a phosphate compound, or a phosphoric acid compound.

The other processes S10 to S20 are the same as those in the first and second examples of the manufacturing method. Thereafter, in the debinding treatment in the firing process S22, phosphorus in the metal patterns 32 diffuse into the green sheets 30. The diffusion of phosphorus from the metal patterns 32 to the green sheets 30 can be controlled by the temperature of the debinding treatment, the molar ratio of phosphorus in the metal patterns 32, and the like. Thereafter, the same process as the firing process S22 is performed.

In the multilayer ceramic capacitor 100 manufactured by the manufacturing method of this example, in the capacitance section 62, phosphorus diffuses from both the internal electrodes 12a and 12b into the dielectric layers 14. Therefore, the phosphorus molar ratio P1 in the dielectric layers 14 is the greatest in the capacitance section 62. In the end margin region 64, phosphorus diffuses from one of the internal electrodes 12a and 12b into the corresponding dielectric layer 14. Therefore, the phosphorus molar ratio P2 in the dielectric layer 14 is smaller than he phosphorus molar ratio P1. Since the internal electrodes 12a and 12b do not exist the insides of the cover dielectric layers 16 and the side margin regions 66, the third molar ratio P3 and the fourth molar ratio P4 of phosphorus in the cover dielectric layers 16 and the side margin regions 66 are lower than the second molar ratio P2.

As a result, the molar ratio P1>P2≥P3 and P1>P2≥P4 and the grain size W1<W2≤W3 and W1<W2≤W4 are satisfied after the firing. Phosphorus may be added to the metal patterns 32, and phosphorus may be added to the green sheets 30 in the same manner as in the first and second examples of the manufacturing method. The green sheets 31 and the dielectric patterns 33 may not be doped with phosphorus, or may be doped with phosphorus in a lower molar ratio than that of the green sheets 30.

In order to diffuse phosphorus into the dielectric layers 14, the molar ratio M2 of phosphorus to the main component metal element in the metal patterns 32 in the process S12 is preferably 0.0003 or more and 0.003 or less (0.03% or more and 0.3% or less). The firing temperature in the firing process S22 is preferably 1500° C. or less, and is more preferably 950° C. or more and 1300° C. or less.

In order to suppress the dielectric breakdown, improve the life, and increase the strength of the element body 10, when the size relationship between the grain sizes W1 to W4 is adjusted to meet a desired relationship, a complicated process such as changing process of the sizes of the ceramic particles in the green sheets 30 and 31 and the ceramic grains in the dielectric patterns 33 is needed. In the first to third examples of the manufacturing methods, the green sheets 30 and 31, the metal patterns 32, and the dielectric patterns 33 have desired molar ratios of phosphorus, so that the size relationships between the grain diameters W1 to W4 can satisfy the desired relationship. Therefore, the life can be improved and the strength of the element body 10 can be increased by using the simplified manufacturing method.

The molar ratio P1 of phosphorus to the main component metal element of the ceramic in the dielectric layers 14 in the capacitance section 62 is, for example, 0.002 or more and 0.02 or less. The molar ratio P2 of phosphorus to the main component metal element of the ceramic in the dielectric layers 14 in the end margin regions 64 is, for example, 0.001 or more 0.01 or less. The third molar ratio P3 of phosphorus to the main component metal element of the ceramic in the cover dielectric layers 16 is, for example, 0 or more and 0.01 or less. The fourth molar ratio P4 of phosphorus to the main component metal element of the ceramic of the dielectric layers 14 in the side margin region 66 is, for example, 0 or more 0.01 or less.

The first molar ratio P1 is preferably twice or more each of the molar ratios P2, P3, and P4, is more preferably five times or more each of the molar ratios P2, P3, and P4, and is still more preferably ten times or more each of the molar ratios P2, P3, and P4. The second molar ratio P2 is preferably one or more times each of the molar ratios P3 and P4, is more preferably twice or more times each of the molar ratios P3 and P4, is still more preferably five or more times each of the molar ratios P3 and P4, and is still more preferably ten or more times each of the molar ratios P2 and P3. In the first example of the manufacturing method of the multilayer ceramic capacitor, the fourth molar ratio P4 is preferably smaller than 0.5 times the second molar ratio P2, is more preferably smaller than 0.2 times the second molar ratio P2, and is still more preferably smaller than 0.1 times the second molar ratio P2.

The ceramic grains 40 in the dielectric layer 14 in the capacitance section 62 have, for example, the grain size W1 of 80 nm or more and 1.5 μm or less, or of 80 nm or more and 500 nm or less. The ceramic grains 40 in the dielectric layers 14 in the end margin regions 64 have, for example, the grain size W2 of 150 nm or more and 2 μm or less, or of 100 nm or more and 1 μm or less. The ceramic grains 40 in the cover dielectric layers 16 have, for example, the grain size W3 of 150 nm or more and 2 μm or less, or of 100 nm or more and 1 μm or less. The ceramic grains 40 in the dielectric layers 14 in the side margin regions 66 have, for example, the grain size W4 of 150 nm or more and 2 μm, or of 100 nm or more and 1 μm or less.

The grain size W1 is preferably 0.9 times or less one of the grain sizes W2, W3, and W4, is more preferably 0.7 times or less the one of the grain sizes W2, W3, and W4, and is still more preferably 0.5 times or less the one of the grain sizes W2, W3, and W4. The grain size W2 is preferably equal to or less than the grain sizes W3 or W4, is more preferably 0.9 times or less the grain sizes W3 or W4, is still more preferably 0.7 times or less the grain sizes W3 or W4, and is still more preferably 0.5 times or less the grain sizes W3 or W4.

In the second embodiment, the grain size W of the ceramic grains 40 is defined by the method described referring to FIGS. 11A and 11B. When the grain size W1 in the dielectric layers 14 of the capacitance section 62, the grain size W2 in the dielectric layers 14 of the end margin regions 64, and the grain size W3 in the cover dielectric layers 16 are different from each other in the Z direction, the grain sizes W1, W2, and W3 are defined as follows. In an electron microscope image, a straight line extending in the Z direction is drawn across the dielectric layer 14 between the adjacent inner electrodes 12a and 12b of the capacitance section 62. The grain size W of all the ceramic grains 40 overlapping the straight line in the dielectric layer 14 is measured. The number of grains 40 for measuring grain size W is set to 10 to 100. When the number of grains 40 for measuring grain sizes is less than 10, an additional straight line is drawn, and the grain size W of the ceramic grains 40 overlapping the additional straight line is measured. The median of the above-mentioned measured grain sizes W of the ceramic grains 40 is defined as the grain size W1. For the grain size W2, a straight line extending in the Z direction to cross the dielectric layer 14 between the adjacent internal electrodes 12a of the end margin region 64 is drawn in the electron microscope image. The grain sizes W of 10 to 100 grains 40 are measured in the same manner as the grain size W1, and the median value of the grain sizes W is defined as the grain size W2. For the grain size W3, a straight line extending in the Z direction to cross the cover dielectric layer 16 is drawn in the electron microscope image. The grain sizes W of 10 to 100 grains 40 are measured in the same manner as the grain size W1, and the median value of the grain sizes W is defined as the grain size W3.

The molar ratio of phosphorus to the main component metal element of the ceramic is measured and calculated using the same method as in the first embodiment. The molar ratio in the dielectric layer 14 of the capacitance section 62, the molar ration in the dielectric layer 14 of the end margin region 64, and the molar ration in the cover dielectric layer 16 is obtained by drawing a straight line crossing the dielectric layer 14 or the cover dielectric layer 16 in the Z direction and averaging the molar ratio of the portions overlapping the straight line in each of the dielectric layers 14 and the cover dielectric layer 16.

In the present specification, the expression “a certain portion has a certain element as a main component” means that the portion may contain the certain element to the extent that the effect of the embodiment is proven to be effective, and the molar ratio of the certain element in the certain portion is, for example, 50 mol % or more, preferably 80 mol % or more, or more preferably 90 mol % or more.

The present disclosure is not limited to the specific embodiment, and various modifications and changes may be made within the scope of the gist of the present disclosure described in the claims.

What is claimed is:

1. A multilayer ceramic electronic component comprising:
an element body in which internal electrodes and dielectric layers mainly composed of ceramic are alternately laminated in a first direction, the element body having a pair of end surfaces facing each other in a second direction, the internal electrodes being alternately drawn to the pair of end surfaces; and
a pair of external electrodes respectively in contact with the internal electrodes drawn to the pair of end surfaces,
wherein when one of the dielectric layers in a capacitance section, which is a central portion of the element body in the second direction as viewed in the first direction and has the internal electrodes overlapping each other, is virtually divided at equal intervals in the first direction into three regions having a pair of first regions and a second region sandwiched between the pair of first regions, a first molar ratio of phosphorus to a main component metal element of ceramic in the pair of first region is greater than a second molar ratio of phosphorus to the main component metal element in the second region.

2. The multilayer ceramic electronic component according to claim 1, wherein
a first grain size of ceramic grains in the pair of first region is smaller than a second grain size of ceramic grains in the second region.

3. The multilayer ceramic electronic component according to claim 1, wherein
the first molar ratio is 1.2 times or more the second molar ratio.

4. The multilayer ceramic electronic component according to claim 1, wherein
a third molar ratio of phosphorus to the main component metal element in a pair of third regions, each range of which is 0.1 times a width of the one of the dielectric layers in the first direction from two of the internal electrodes adjacent to the one of the dielectric layers, is 1.5 times or more a fourth molar ratio of phosphorus to the main component metal element in the dielectric layers.

5. The multilayer ceramic electronic component according to claim 1, wherein
a grain size of a ceramic grain, which is not adjacent to the internal electrodes and is adjacent to another ceramic grain in contact with one of the internal electrodes, is smaller than a grain size of the ceramic grains in the second region in the one of the dielectric layers.

6. The multilayer ceramic electronic component according to claim 1, wherein
a number of the ceramic grains arranged in the first direction in the one of the dielectric layers is five or more.

7. The multilayer ceramic electronic component according to claim 1, wherein
a main component of the ceramic is barium titanate, and
a main component of the internal electrodes is nickel.

8. A multilayer ceramic electronic component comprising:
an element body in which internal electrodes and dielectric layers mainly composed of ceramic are alternately laminated in a first direction, the element body having a pair of end surfaces facing each other in a second direction, the internal electrodes being alternately drawn to the pair of end surfaces; and
a pair of external electrodes respectively in contact with the internal electrodes drawn to the pair of end surfaces,
wherein a first molar ratio of phosphorus to a main component metal element of ceramic in a capacitance section in which the internal electrodes overlap each other is greater than a second molar ratio of phosphorus to the main component metal element in an end margin region in which some of the internal electrodes are not provided,
the capacitance section is a central portion of the element body in the second direction as viewed in the first direction, and
the end margin region is an end portion of the element body in the second direction as viewed in the first direction.

9. The multilayer ceramic electronic component according to claim 8, wherein
a first grain size of ceramic grains in the dielectric layers in the capacitance section is smaller than a second grain size of ceramic grains in the dielectric layers in the end margin region.

10. The multilayer ceramic electronic component according to claim 8, wherein
a third molar ratio of phosphorus to the main component metal element in an outermost cover dielectric layer among the dielectric layers is smaller than the first molar ratio.

11. The multilayer ceramic electronic component according to claim 10, wherein
a first grain size of ceramic grains in the dielectric layers in the capacitance section is smaller than a second grain size of ceramic grains in a dielectric in the end margin region, and
a third grain size of ceramic grains in the cover dielectric layer is greater than the first grain size.

12. The multilayer ceramic electronic component according to claim 10, wherein
the third molar ratio is smaller than the second molar ratio.

13. The multilayer ceramic electronic component according to claim 12, wherein
a first grain size of ceramic grains in the dielectric layers in the capacitance section is smaller than a second grain size of ceramic grains in the dielectric layers in the end margin region, and
a third grain size of ceramic grains in the cover dielectric layer is greater than the first grain size.

14. The multilayer ceramic electronic component according to claim 10, wherein
a fourth molar ratio of phosphorus to the main component metal element in a dielectric in a side margin region in which the internal electrodes are not provided is smaller than the first molar ratio, and
the side margin region is an end portion of the element body in a third direction intersecting with the first direction and the second direction as viewed in the first direction.

15. The multilayer ceramic electronic component according to claim 14, wherein the fourth molar ratio is equal to or less than the second molar ratio.

16. A manufacturing method of a multilayer ceramic electronic component, the manufacturing method comprising:
preparing an element body in which green sheets containing ceramic particles and metal patterns containing phosphorus are alternately laminated in a first direction;
firing the element body to form internal electrodes alternately drawn to a pair of end surfaces of the element body facing each other in a second direction from the metal patterns and to form dielectric layers from the green sheets; and
forming a pair of external electrodes in contact with the internal electrodes drawn to the pair of end surfaces,
wherein, after firing the element body, when one of the dielectric layers in a capacitance section, which is a central portion of the element body in the second direction as viewed in the first direction and has the internal electrodes overlapping each other, is virtually divided at equal intervals in the first direction into three regions having a pair of first regions and a second region sandwiched between the pair of first regions, a first molar ratio of phosphorus to a main component metal element of ceramic grains in the pair of first region is greater than a second molar ratio of phosphorus to the main component metal element in the second region.

17. The manufacturing method according to claim 16, wherein
a main component of the ceramic particles is barium titanate, and
a main component of the internal electrodes is nickel.

18. A manufacturing method of a multilayer ceramic electronic component, the manufacturing method comprising:
preparing an element body in which lamination sheets are laminated in a first direction, the lamination sheets having metal patterns and dielectric patterns containing ceramic particles formed on green sheets containing the ceramic particles, the dielectric patterns being formed between the metal patterns;
firing the element body to form internal electrodes alternately drawn to a pair of end surfaces of the element body facing each other in a second direction from the metal patterns and to form dielectric layers from the green sheets and the dielectric patterns; and
forming a pair of external electrodes in contact with the internal electrodes drawn to the pair of end surfaces,
wherein a first molar ratio of phosphorus to a main component metal element of the ceramic particles in the green sheets sandwiched between the metal patterns in the first direction is greater than a second molar ratio of phosphorus to the main component metal element in the dielectric patterns.

19. The manufacturing method according to claim 18, wherein
a third molar ratio of phosphorus to the main component metal element in the outermost one of the green sheets in the first direction in the element body is smaller than the first molar ratio.

20. The manufacturing method according to claim 19, wherein
the preparing the element body includes preparing a laminate in which the metal patterns are drawn to a pair of side surfaces facing each other in a third direction intersecting the first and second direction and attaching a pair of side green sheets containing ceramic particles to the pair of side surfaces of the laminate respectively, and
a fourth molar ratio of phosphorus to the main component metal element in the pair of side green sheets is smaller than the first molar ratio.

21. The manufacturing method according to claim 18, wherein
after the element body is fired, a fifth molar ratio of phosphorus to the main component metal element in the dielectric layers in a capacitance section in which the internal electrodes overlap each other is greater than a sixth molar ratio of phosphorus to the main component metal element in the dielectric layers in an end margin region in which some of the internal electrodes are not provided,
the capacitance section is a central portion of the element body in the second direction as viewed in the first direction, and
the end margin region is an end portion of the element body in the second direction as viewed in the first direction.

22. A manufacturing method of a multilayer ceramic electronic component, the manufacturing method comprising:
preparing an element body in which lamination sheets are laminated in a first direction, the lamination sheets having metal patterns containing phosphorus and dielectric patterns containing ceramic particles formed on green sheets containing the ceramic particles, the dielectric patterns being formed between the metal patterns;
firing the element body to form internal electrodes alternately drawn to a pair of end surfaces of the element body facing each other in a second direction from the metal patterns and to form dielectric layers from the green sheets and the dielectric patterns; and
forming a pair of external electrodes in contact with the internal electrodes drawn to the pair of end surfaces,
wherein a first molar ratio of phosphorus to a main component metal element of ceramic in a capacitance section in which the internal electrodes overlap each other is greater than a second molar ratio of phosphorus to the main component metal element in an end margin region in which some of the internal electrodes are not provided,
the capacitance section is a central portion of the element body in the second direction as viewed in the first direction, and
the end margin region is an end portion of the element body in the second direction as viewed in the first direction.
